(19) United States
(12) Patent Application Publication
(10) Pub. No.: US 2013/0193131 A1
(43) Pub. Date: Aug. 1, 2013

(54) OPTICAL PYROMETER AND APPARATUS FOR PROCESSING SEMICONDUCTOR BY EMPLOYING THE SAME

(71) Applicant: SAMSUNG ELECTRONICS CO., LTD., Suwon-ri (KR)

(72) Inventors: In-hoe HUR, Anyang-si (KR); Dong-myung SHIN, Suwon-si (KR); Jong-pa HONG, Yongin-si (KR); Choo-ho KIM, Yongin-si (KR); Won-soo JI, Hwaseong-si (KR); Jun-woo KIM, Gunpo-si (KR)

(73) Assignee: SAMSUNG ELECTRONICS CO., LTD., Suwon-ri (KR)

(21) Appl. No.: 13/706,146

(22) Filed: Dec. 5, 2012

(30) Foreign Application Priority Data
Jan. 30, 2012 (KR) 10-2012-0009205

(51) Int. Cl. G01J 5/00; H05B 1/00

(52) U.S. Cl. CPC G01J 5/00; H05B 1/00
USPC 219/385; 356/43

(57) ABSTRACT

An optical pyrometer includes a receiving part having a receiving end for receiving light radiation of a heating unit, and a case part covering the receiving part, except for the receiving end of the receiving part, wherein a cross-sectional area of the receiving end of the receiving part perpendicular to a lengthwise direction of the receiving end of the receiving part decreases toward an end portion of the receiving end of the receiving part.

### CROSS-REFERENCE TO RELATED APPLICATIONS

This application claims the benefit of Korean Patent Application No. 10-2012-0009205, filed on Jan. 30, 2012, in the Korean Intellectual Property Office, the disclosure of which is incorporated herein in its entirety by reference.

### BACKGROUND

1. Field

The present disclosure relates to an optical pyrometer and an apparatus for processing a semiconductor by employing the same, and more particularly, to an optical pyrometer in which the structure of a receiving part is improved, and an apparatus for processing a semiconductor by employing the same.

2. Description of the Related Art

In a semiconductor processing apparatus, processing a semiconductor generally requires a thermal treatment. For example, in a chemical vapor deposition apparatus, epitaxial growth of an organic compound is a thermal-chemical reaction. In the thermal treatment, a mechanically accurate measurement and temperature control are essential for quality and reliable film formation.

In the semiconductor processing apparatus, an optical pyrometer for measuring a temperature from light irradiated by a heat source, for example, a heated wafer or a heated support of a wafer, is used as an apparatus for measuring a temperature.

### SUMMARY

Provided is an optical pyrometer having a structure to reduce contamination of a receiving part, and an apparatus for processing a semiconductor by employing the same.

Additional aspects will be set forth in part in the description which follows and, in part, will be apparent from the description, or may be learned by practice of the presented exemplary embodiments.

According to an aspect of the present disclosure, an optical pyrometer includes a receiving part having a receiving end for receiving light radiation of a heating unit, and a case part covering the receiving part, except for the receiving end of the receiving part, wherein a cross-sectional area of the receiving end of the receiving part perpendicular to a lengthwise direction of the receiving end of the receiving part decreases toward an end portion of the receiving end of the receiving part.

The receiving end of the receiving part may have any one of a semispherical shape, a taper shape, a circular cone shape, a circular truncated cone shape, a polygonal cone shape, and a polygonal truncated cone shape.

The optical pyrometer may further include a purge gas injection part for injecting a purge gas between the receiving part and the case part.

A flow rate of the purge gas injected through the purge gas injection part may be set as a value at which an eddy generated at the receiving end of the receiving part is a maximum.

The receiving part may include an optical pipe for transmitting light.

The receiving part may be formed of a transparent material.

An end portion of the case part may protrude with respect to the end portion of the receiving end of the receiving part.

The receiving end of the receiving part may be arranged adjacent to the heating unit.

According to another aspect of the present disclosure, a semiconductor processing apparatus includes a chamber for accommodating a substrate for processing a semiconductor, a heating unit for heating an inside of the chamber, and a pyrometer for detecting a temperature of the inside of the chamber, the pyrometer comprising a receiving part having a receiving end for receiving light radiation of the heating unit and a case part covering the receiving part, except for the receiving end of the receiving part, wherein a cross-sectional area of the receiving end of the receiving part perpendicular to a lengthwise direction of the receiving end of the receiving part decreases toward an end portion of the receiving end of the receiving part.

The receiving end of the receiving part may have any one of a semispherical shape, a taper shape, a circular cone shape, a circular truncated cone shape, a polygonal cone shape, and a polygonal truncated cone shape.

The semiconductor processing apparatus may further include a purge gas injection part for injecting a purge gas between the receiving part and the case part.

A flow rate of the purge gas injected through the purge gas injection part may be set as a value at which an eddy generated at the receiving end of the receiving part is a maximum.

The receiving part may include an optical pipe for transmitting light.

The receiving part may be formed of a transparent material.

An end portion of the case part may protrude with respect to an end portion of the receiving end of the receiving part.

The receiving end of the receiving part may be arranged adjacent to the heating unit.

The semiconductor processing apparatus may be an organic chemical deposition apparatus.

The semiconductor processing apparatus may further include a support, heated by the heating unit, for supporting the substrate in the chamber, wherein the receiving end of the receiving part is arranged adjacent to the support.

The support may be a susceptor for supporting the substrate.

According to another aspect of the present disclosure, an optical pyrometer includes a case part including a hollow pipe, the hollow pipe having an open end; and a receiving part having a receiving end, the receiving part being arranged inside the hollow pipe such that the receiving end is located adjacent to the open end, wherein a cross-sectional area of the receiving end decreases in a lengthwise direction toward an end portion of the receiving end.

The receiving end of the receiving part may have any one of a semispherical shape, a taper shape, a circular cone shape, a circular truncated cone shape, a polygonal cone shape, and a polygonal truncated cone shape.

The optical pyrometer may include a purge gas injection part for injecting a purge gas between the receiving part and the case part.

The flow rate of the purge gas injected through the purge gas injection part may be set as a value at which an eddy generated at the receiving end of the receiving part is a maximum.

The receiving part may include an optical pipe for transmitting light.

The open end of the case part may protrude with respect to the end portion of the receiving end of the receiving part.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic cross-sectional view of a pyrometer according to an embodiment of the present disclosure;

FIG. 2 illustrates an example of the structure of a receiving end of a receiving part in the pyrometer of FIG. 1;

FIGS. 3A and 3B illustrate other examples of the structure of a receiving end of a receiving part in the pyrometer of FIG. 1;

FIG. 4 illustrates the flow of a purge gas observed near a receiving end of a receiving part in a pyrometer according to an embodiment of the present disclosure;

FIG. 5 illustrates the flow of a purge gas observed near a receiving end of a receiving part in a pyrometer according to a comparative example;

FIG. 6 is a graph showing contamination amounts measured at a receiving end of a receiving part in a pyrometer according to an embodiment of the present disclosure and a pyrometer according to a comparative example; and

FIG. 7 is a schematic cross-sectional view of a semiconductor processing apparatus employing the pyrometer of FIG. 1.

### DETAILED DESCRIPTION

Reference will now be made in detail to exemplary embodiments, examples of which are illustrated in the accompanying drawings, wherein like reference numerals refer to the like elements throughout. In this regard, the present exemplary embodiments may have different forms and should not be construed as being limited to the descriptions set forth herein. Accordingly, the embodiments are merely described below, by referring to the figures, to explain aspects of the present disclosure. Expressions such as “at least one of,” when preceding a list of elements, modify the entire list of elements and do not modify the individual elements of the list.

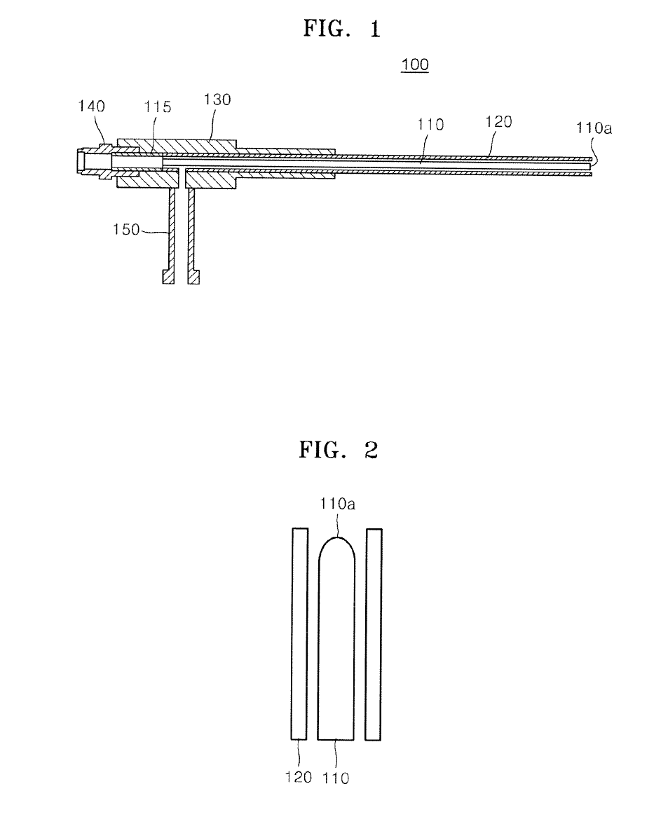

FIG. 1 is a schematic cross-sectional view of a pyrometer 100 according to an exemplary embodiment of the present disclosure. FIG. 2 illustrates an example of the structure of a receiving end 110a of a receiving part 110 in the pyrometer 100 of FIG. 1.

Referring to FIGS. 1 and 2, the pyrometer 100 according to the present embodiment includes the receiving part 110 for receiving light irradiated by a heating body, a case part 120 for protecting the receiving part 110, and a housing 130 for coupling the receiving part 110 and the case part 120. The receiving part 110 is formed of a transparent material and may be, for example, a light pipe. One end of the receiving part 110 is the receiving end 110a for receiving light, whereas the other end of the receiving part 110 is connected to a light receiving device (not shown). The case part 120 may have a shape of a hollow pipe. An end of the case part 120 may extend slightly longer than the receiving end 110a of the receiving part 110. An optical fiber cable for connecting the other end of the receiving part 110 to a photodetector (not shown) is inserted in a ferrule assembly 140. In some cases, a light receiving device may be directly attached to the other end of the receiving part 110.

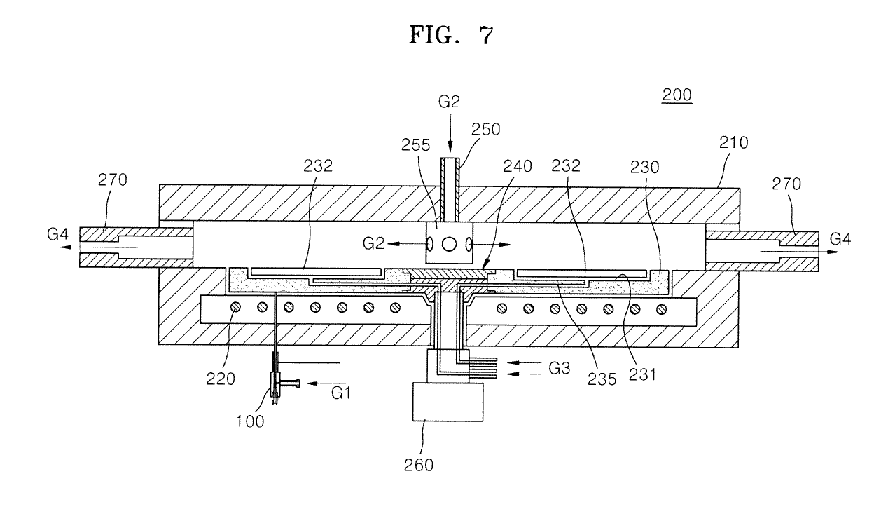

A purge gas injection part 150 for injecting a purge gas into a space between the receiving part 110 and the case part 120 may be provided. The purge gas injection part 150 is connected to a purge gas supply source (not shown). The purge gas may be an inert gas or a non-reactive gas such as nitrogen that does not substantially chemically react. The purge gas is injected into a space between the receiving part 110 and the case part 120 and emitted toward the receiving end 110a of the receiving part 110. The purge gas restricts contact between the receiving part 110 and the reactive gas filling the inside of a chamber (refer to 210 of FIG. 7) so that contamination of the receiving part 110 by the reactive gas can be prevented.

Referring to FIG. 2, the receiving end 110a of the receiving part 110 may have a semispherical shape. Because the receiving end 110a has a semispherical shape, an eddy can be efficiently generated by the purge gas ejected through the gap between the receiving part 110 and the case part 120 so that the receiving end 110a of the receiving part 110 may be effectively covered with the purge gas. When the purge gas covers the receiving end 110a, ill effects that may result from the receiving end 110a being contaminated by the reactive gas in the chamber of a semiconductor processing apparatus where the pyrometer 100 is used may be prevented.

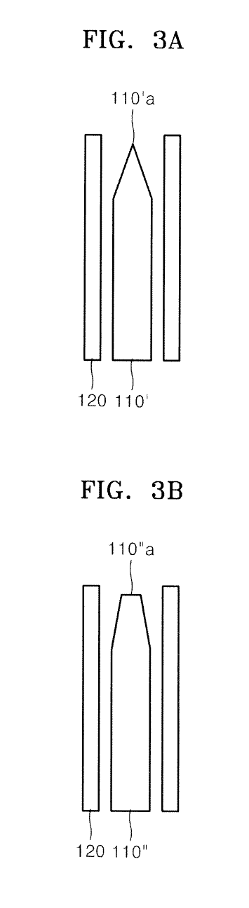

The semispherical shape of the receiving end 110a according to the present embodiment is a mere example of a shape in which a cross-sectional area of a receiving end perpendicular to a lengthwise direction thereof decreases toward an end portion, but the present disclosure is not limited thereto. For example, as illustrated in FIG. 3A, a receiving end 110′a of a receiving part 110′ may have a taper shape in which an end portion is gradually sharpened, such as a circular cone shape or a polypyramid shape. Referring to FIG. 3B, a receiving end 110″a has a circular truncated cone shape or a truncated polypyramid shape with a flat upper surface. A circular truncated cone shape or a truncated polypyramid shape may be modified to have a round upper surface. Any receiving end having a shape in which a cross-sectional area of the receiving end perpendicular to a lengthwise direction thereof decreases toward an end portion can generate the eddy discussed above.

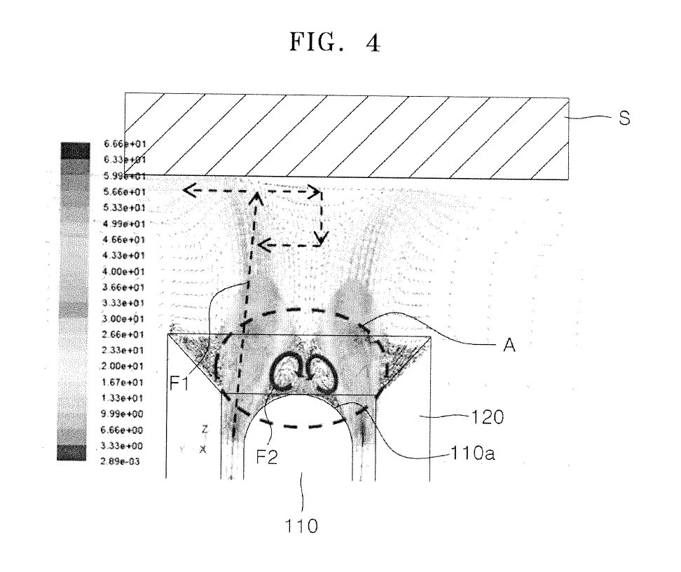

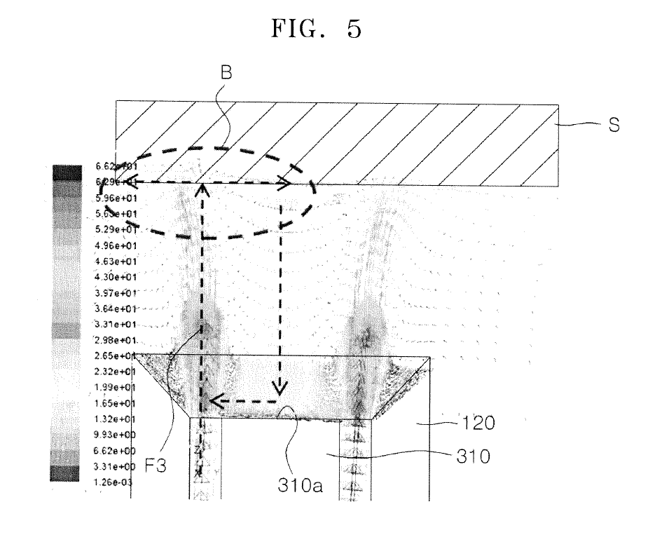

FIG. 4 illustrates the flow of a purge gas observed near a receiving end of a receiving part in a pyrometer according to an embodiment of the present disclosure. FIG. 5 illustrates the flow of a purge gas observed near a receiving end of a receiving part in a pyrometer according to a comparative example.

Referring to FIG. 4, the receiving end 110a of the receiving part 110 of the pyrometer 100 according to the present exemplary embodiment has a semispherical shape. Accordingly, the purge gas ejected through the gap between the receiving part 110 and the case part 120 has not only a straight flow F1 but also an eddy F2 generated in an area “A” adjacent to the receiving end 110a due to the semispherical shape of the receiving end 110a. The eddy F2 of the purge gas makes the area “A” a closed system surrounded by the purge gas so that the receiving end 110a can be prevented from being contaminated by the reactive gas filling the space where the receiving part 110 is located, for example, inside a chamber. Also, a semiconductor processing apparatus using the pyrometer 100 generates a thermal-chemical reaction at a high temperature over hundreds of degrees. Thus, by restricting an increase in the temperature of the receiving end 110a, the contamination of the receiving end 110a by the reactive gas may be restricted. That is, in the pyrometer 100 according to the present embodiment, the purge gas can prevent the receiving end 110a from contacting the reactive gas that is heated to a high temperature so that an increase in the temperature of the receiving end 110a can be restricted. Thus, the contamination of the receiving end 110a by the reactive gas may be restricted.

Referring to FIG. 5, in a pyrometer according to a comparative example, a receiving end 310a of a receiving part 310 has a flat surface. In this case, a flow F3 of the purge gas ejected through a gap between the receiving part 310 and the case part 120 tends to be further straight. As a result, the purge gas collides against an area “B” of a heating body S and goes back toward the receiving end 310a. During the flow of the purge gas, the purge gas is mixed with part of the reactive gas filling a space (such as the inside of a chamber where the receiving part 310 is located) so that the receiving end 310a may be contaminated by the reactive gas. Also, because the purge gas is mixed with reactive gas that is heated to a high temperature, the receiving end 310a is heated to a high temperature so that the contamination by the reactive gas may become more active.

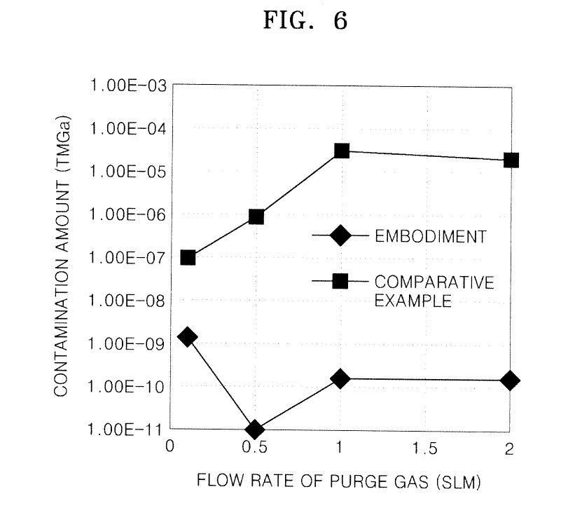

FIG. 6 is a graph showing contamination amounts measured at a receiving end of a receiving part in the pyrometer 100 according to an exemplary embodiment of the present disclosure and a pyrometer according to a comparative example. A reactive gas is trimethyl-Ga (TMGa) that is generally used in an organic chemical deposition apparatus. A concentration, that is, a contamination amount, of TMGa accumulating at a receiving end varies according to a flow rate of a purge gas that is injected. As seen in FIG. 6, the contamination amount of TMGa measured by a pyrometer according to a comparative example tends to increase as the flow rate of a purge gas increases. In contrast, the contamination amount measured by the pyrometer 100 according to the present embodiment has a minimum value when the flow rate of a purge gas is 0.5 SLM, and the contamination amount is much smaller than the contamination amount of the pyrometer according to the comparative example. In the present embodiment, the flow rate of the purge gas when the contamination amount is the maximum may be understood as a flow rate when the minimum amount of an eddy is formed at the receiving end 110a of FIG. 2.

FIG. 7 is a schematic cross-sectional view of a semiconductor processing apparatus 200 employing the pyrometer 100 of FIG. 1. In FIG. 7, the semiconductor processing apparatus 200 employing the pyrometer 100 of FIG. 1 is a chemical vapor deposition apparatus.

Referring to FIG. 7, the semiconductor processing apparatus 200 according to the present exemplary embodiment includes a chamber 210 for accommodating a wafer, a heating unit 220 for heating the inside of the chamber 210, and the pyrometer 100 for measuring a temperature of the inside of the chamber 210. A susceptor 230 where the wafer is accommodated and a nozzle 255 of a reactive gas injection part 250 are located in the chamber 210. Also, the receiving end (refer to 110a of FIG. 1) of the receiving part 110 of the pyrometer 100 is arranged in the chamber 210 to be close to the susceptor 230. For example, the pyrometer 100 is arranged in a lower portion of the chamber 210 with the receiving part 110 of the pyrometer 100 penetrating a lower surface of the chamber 210 so that an end portion of the receiving part 110 may be arranged adjacent to a rear surface of the susceptor 230. The pyrometer 100 measures a temperature of the susceptor 230 heated by the heating unit 220. As described above, the receiving end 110a of the receiving part 110 may have a semispherical shape, a taper shape, a circular cone shape, a circular truncated cone shape, a polygonal cone shape, or a polygonal truncated cone shape, to prevent contamination by a reactive gas G2. Also, to prevent the contamination of the receiving end 110a of the receiving part 110, a purge gas G1 is injected into the pyrometer 100 during which a deposition process is performed in the chamber 210.

The chamber 210 is hermetically closed during the deposition process and may be open for changing an object to be deposited.

A plurality of pockets 231 are provided on an upper surface of the susceptor 230. Each of the pockets 231 is a recess formed at a predetermined depth from the upper surface of the susceptor 230. A satellite disc 232 having a circular disc type is accommodated in each of the pockets 231. A wafer subject to deposition is placed on the satellite disc 232. The susceptor 230 may be rotated for uniform deposition as a support part assembly 240 for supporting the susceptor 230 is rotated by a motor 260. Gas flow paths 235 for supplying a flow gas G3 to the pockets 231 may be formed in the susceptor 230 and the support part assembly 240 supporting the susceptor 230. A frictional force between the satellite disc 232 and a bottom of each of the pockets 231 may be sufficiently reduced to be negligible during the rotation of the satellite disc 232 due to a cushion effect by the flow gas G3.

The heating unit 220 is arranged on a rear surface of the susceptor 230 and heats the susceptor 230 to a predetermined temperature. For example, when a GaN-based growth layer is to be formed, the heating unit 220 may heat the susceptor 230 to a temperature of about 500-1500° C. The heating unit 220 may be a coil to which a high frequency current is applied. In this case, the susceptor 230 may be heated by an induction heating method. In another example, the heating unit 220 may be a wire that resistance-heats.

The reactive gas injection part 250 is a device for supplying the reactive gas G2 including a source gas and a carrier gas to use for depositing an object to be deposited. The nozzle 255 of the reactive gas injection part 250 is exposed to the inside of the chamber 210 and ejects the reactive gas G2.

A gas exhaust part 270 exhausts an exhaust gas G4 including the purge gas the reactive gas G2, and the flow gas G3 out of the chamber 210. The object to be deposited may maintain a high temperature due to the susceptor 230 heated to a high temperature. An upper surface of the object to be deposited contacts the reaction gas G2 and performs a chemical deposition reaction. The chemical deposition reaction makes a predetermined material, such as a GaN-based compound crystal, grow on the object to be deposited such as a wafer. A chemical vapor deposition apparatus that grows an organic compound crystal through a thermal-chemical reaction needs mechanically accurate temperature measurement and control to form a superior and reliable thin film. In the semiconductor processing apparatus 200 according to the present embodiment, since the structure of the receiving part 110 of the pyrometer 100 is improved, contamination of the receiving part 110 by the reactive gas G2 can be prevented so that a thin film that is superior and reliable in mechanically accurate temperature measurement and control may be formed.

As described above, in the optical pyrometer and the semiconductor processing apparatus employing the same according to the present disclosure, a temperature measurement error due to contamination can be reduced so that reliability in measuring a temperature can be improved. Also, since a replacement cycle of the receiving part of a pyrometer can be extended, management and repair costs may be reduced.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. An optical pyrometer comprising:
a receiving part having a receiving end for receiving light radiation of a heating unit; and
a case part covering the receiving part, except for the receiving end of the receiving part,
wherein a cross-sectional area of the receiving end of the receiving part perpendicular to a lengthwise direction of the receiving end of the receiving part decreases toward an end portion of the receiving end of the receiving part.

2. The optical pyrometer of claim 1, wherein the receiving end of the receiving part has any one of a semispherical shape, a taper shape, a circular cone shape, a circular truncated cone shape, a polygonal cone shape, and a polygonal truncated cone shape.

3. The optical pyrometer of claim 1, further comprising a purge gas injection part for injecting a purge gas between the receiving part and the case part.

4. The optical pyrometer of claim 3, wherein a flow rate of the purge gas injected through the purge gas injection part is set as a value at which an eddy generated at the receiving end of the receiving part is a maximum.

5. The optical pyrometer of claim 1, wherein the receiving part includes an optical pipe for transmitting light.

6. The optical pyrometer of claim 1, wherein an end portion of the case part protrudes with respect to the end portion of the receiving end of the receiving part.

7. A semiconductor processing apparatus comprising:
a chamber for accommodating a substrate for processing a semiconductor;
a heating unit for heating an inside of the chamber; and
a pyrometer for detecting a temperature of the inside of the chamber, the pyrometer comprising a receiving part having a receiving end for receiving light radiation of the heating unit and a case part covering the receiving part, except for the receiving end of the receiving part,
wherein a cross-sectional area of the receiving end of the receiving part perpendicular to a lengthwise direction of the receiving end of the receiving part decreases toward an end portion of the receiving end of the receiving part.

8. The semiconductor processing apparatus of claim 7, wherein the receiving end of the receiving part has any one of a semispherical shape, a taper shape, a circular cone shape, a circular truncated cone shape, a polygonal cone shape, and a polygonal truncated cone shape.

9. The semiconductor processing apparatus of claim 7, further comprising a purge gas injection part for injecting a purge gas between the receiving part and the case part.

10. The semiconductor processing apparatus of claim 9, wherein a flow rate of the purge gas injected through the purge gas injection part is set as a value at which an eddy generated at the receiving end of the receiving part is a maximum.

11. The semiconductor processing apparatus of claim 9, wherein the receiving part includes an optical pipe for transmitting light.

12. The semiconductor processing apparatus of claim 9, wherein an end portion of the case part protrudes with respect to an end portion of the receiving end of the receiving part.

13. The semiconductor processing apparatus of claim 9, wherein the semiconductor processing apparatus is an organic chemical deposition apparatus.

14. The semiconductor processing apparatus of claim 9, further comprising a support, heated by the heating unit, for supporting the substrate in the chamber, wherein the receiving end of the receiving part is arranged adjacent to the support.

15. An optical pyrometer comprising:
a case part including a hollow pipe, said hollow pipe having an open end; and
a receiving part having a receiving end, said receiving part being arranged inside the hollow pipe such that the receiving end is located adjacent to the open end, wherein a cross-sectional area of the receiving end decreases in a lengthwise direction toward an end portion of the receiving end.

16. The optical pyrometer of claim 15, wherein the receiving end of the receiving part has any one of a semispherical shape, a taper shape, a circular cone shape, a circular truncated cone shape, a polygonal cone shape, and a polygonal truncated cone shape.

17. The optical pyrometer of claim 15, further comprising a purge gas injection part for injecting a purge gas between the receiving part and the case part.

18. The optical pyrometer of claim 17, wherein a flow rate of the purge gas injected through the purge gas injection part is set as a value at which an eddy generated at the receiving end of the receiving part is a maximum.

19. The optical pyrometer of claim 15, wherein the receiving part includes an optical pipe for transmitting light.

20. The optical pyrometer of claim 15, wherein the open end of the case part protrudes with respect to the end portion of the receiving end of the receiving part.
